(19) United States
(12) Patent Application Publication
(10) Pub. No.: US 2011/0131974 A1
(43) Pub. Date: Jun. 9, 2011

(54) VEHICLE BRAKE SYSTEM

(76) Inventors: Rainer BRUEGGEMANN, Ludwigsburg (DE); Philipp Frueh, Ludwigsburg (DE)

(21) Appl. No.: 12/951,771

(22) Filed: Nov. 22, 2010

(30) Foreign Application Priority Data
Dec. 9, 2009 (DE) 10 2009 047 738.1

(51) Int. Cl. B60T 13/58

(52) U.S. Cl. 60/565

(57) ABSTRACT

The invention relates to a vehicle brake system, having at least one supply container for delivering brake fluid to a master cylinder and/or to at least one wheel brake of the vehicle brake system. A precharging apparatus for increasing the effective pressure in the supply container is provided, in which the precharging apparatus generates compressed air for increasing the pressure. According to the invention, the precharging apparatus includes a first precharging device, which generates the compressed air from exhaust gases of an exhaust system of the vehicle, and/or a second precharging device, which generates the compressed air from the relative wind.

### CROSS-REFERENCE TO RELATED APPLICATION

This application is based on German Patent Application 10 2009 047 738.1 filed on Dec. 9, 2009.

### BACKGROUND OF THE INVENTION

1. Field of the Invention

The invention relates to a vehicle brake system, having at least one supply container for delivering brake fluid to a master cylinder and/or to at least one wheel brake of the vehicle brake system.

2. Description of the Prior Art

In a known vehicle brake system of this kind, brake fluid for the master cylinder and for a brake pressure modulating valve assembly is furnished in the precharging apparatus, and the valve assembly can deliver the brake fluid selectively to one or more wheel brakes of the vehicle. In the brake pressure modulating valve assembly, a feed pump in particular is provided, with which, for raising the brake pressure in wheel brake cylinders, brake fluid can be aspirated from the supply container and through the master cylinder.

From German Patent disclosure DE 10 2004 049 088 A1, for instance, a vehicle brake system is known which includes a supply container for delivering brake fluid to a master cylinder and/or to a wheel brake of the vehicle brake system. To raise the pressure in the supply container above the air pressure in the surroundings of the vehicle brake system, the vehicle brake system has a precharging device, which is supplied with compressed air for actuation. The increase in the pressure in the supply container thus increases the pressure difference between the supply container and the feed pump inlet.

### ADVANTAGES AND SUMMARY OF THE INVENTION

The vehicle brake system according to the invention has the advantage over the prior art that simple, economical embodiments of a precharging apparatus for generating compressed air are proposed for increasing the pressure in the supply container of the brake fluid. According to the invention, the precharging apparatus includes a first precharging device, which generates the compressed air from exhaust gases of an exhaust system of the vehicle, and/or a second precharging device, which generates the compressed air from the relative wind. In the vehicle brake system of the invention, the relative wind pressure generated by the motion of the vehicle, or the pressure in the exhaust system of the vehicle generated by the operation of the vehicle, automatically ensures the adequate flow of brake fluid from the supply container into the master cylinder during vehicle operation. Advantageously, this process is noiseless and takes place without using a precharging pump, making it possible to save both energy costs and the cost of a high-quality and hence expensive precharging pump. This way of increasing the pressure difference between the supply container of the brake fluid and an inlet of a feed pump advantageously leads to improved filling of the feed pump with brake fluid, so that the feeding capacity of the feed pump and consequently the pressure buildup dynamics of the vehicle brake system as well can be improved. In particular, for large-volume vehicle brake systems, larger feed pumps are not needed; instead, feed pumps with a lesser feeding capacity used thus far can continue to be used. Moreover, optimizing the suction path, for instance by increasing the effective diameter of a suction line or enlarging the high-pressure switching valves disposed in the suction path, can advantageously be dispensed with.

One preferred realization of the vehicle brake system of the invention provides that by means of the compressed air, the effective pressure in the supply container can be raised above the actual pressure in the surroundings of the vehicle brake system. As a result, between the supply container of the brake fluid and a downstream feed pump, there is advantageously always a greater pressure gradient, for optimizing the feed capacity of the feed pump to supply the wheel brakes of the vehicle brake system with brake fluid. As a result, embodiments of the invention are capable of overcoming the flow resistance in the suction line of the feed pump, a resistance that is generated for instance by the master cylinder as well as by suction and inlet valves, and of furnishing an adequate quantity of brake fluid at the feed pump essentially independently of the ambient air pressure. This means that the precharging apparatus of the invention makes it possible for pressure losses, caused in the vehicle brake system by components of the vehicle brake system, to be compensated for.

In a feature of the vehicle brake system of the invention, the second precharging device has at least one sealing element for compressing the air of the relative wind. Preferably, the sealing element is embodied essentially as a funnel element, so that the pilot pressure generated according to the invention in the supply container can advantageously be furnished by means of a comparatively inexpensive device. The device generates a pressure on the brake fluid in the supply container especially simply in terms of physics.

In a further feature of the vehicle brake system of the invention, the funnel element is disposed for example in the front region of the vehicle, preferably in the vicinity of a radiator of the vehicle. This disposition of the funnel element has the advantage that the structural height of the supply container is not increased, since the sealing element for compressing the air of the relative wind need not be accommodated between or in existing components of the vehicle brake system, but instead can be mounted at a point where free space is available and where an adequate quantity of relative wind can be received for generating the compressed air for increasing the pressure in the brake fluid supply container. In the vicinity of the vehicle radiator, the sealing element, embodied as a funnel element, can be integrated with the radiator or mounted as a comparatively inexpensive and space-saving device on the radiator, so that no additional space is required for it. For implementing the invention, basically no additional provisions at the brake fluid supply container are necessary for generating the overpressure according to the invention in the supply container securely over the service life of the vehicle brake system.

### BRIEF DESCRIPTION OF THE DRAWING

The invention will be better understood and further objects and advantages thereof will become more apparent from the ensuing detailed description of a preferred embodiment taken in conjunction with the drawing, in which:.

FIG. 1 is a schematic illustration of a portion of an exemplary embodiment of a vehicle brake system of the invention.

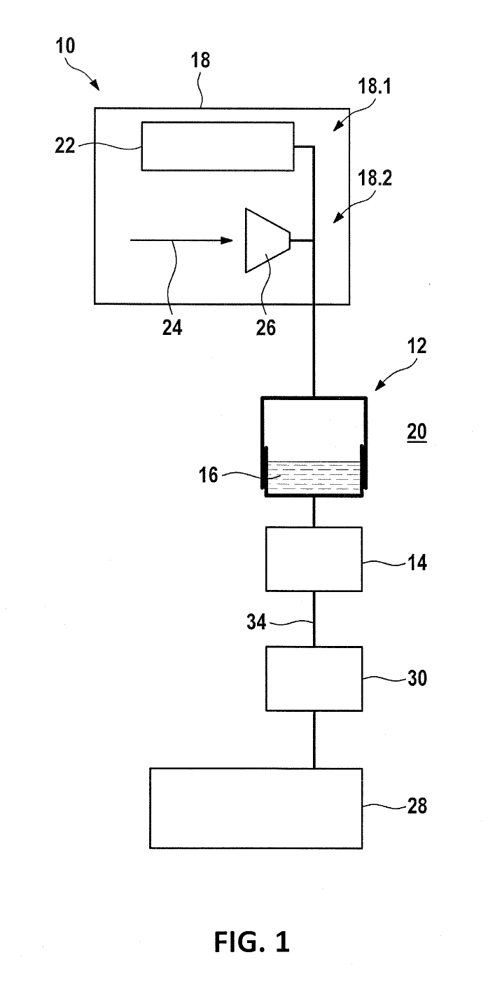

### DESCRIPTION OF THE PREFERRED EMBODIMENT

Upon the aspiration of brake fluid, for instance during a traction control or vehicle dynamics control event, the brake fluid flows only comparatively slowly toward the feed pump. For vehicle dynamics control, however, a very rapid pressure buildup is necessary. In a hydraulic self-aspirating TCS (Traction Control System) and/or ESP (Electronic Stability Program), the requisite volume flow is dependent for instance on the pressure difference between the supply container and the feed pump inlet and on the temperature of the brake fluid, if no precharging pump is used. Both a decrease in the pressure difference and a drop in temperature adversely affect the pressure buildup dynamics in the brakes, or in other words in the vehicle brake system. The brake fluid supply container is at the pressure level of the surroundings. The ambient air pressure is affected by the applicable weather situation, such as high pressure or low pressure, and above all on the altitude. The theoretically maximum pressure difference between the supply container and the feed pump inlet thus corresponds to the ambient air pressure, since at the inlet to the feed pump a pressure of approximately 0 bar is present. The slight pressure difference between the supply container and the feed pump inlet and the decrease in the pressure difference as a function of the altitude has an adverse effect, especially in large-volume brake systems or vehicle brake systems, often also with large idle volumes in the brakes, on the pressure buildup dynamics and thus on the performance of the vehicle traction control system and electronic stability program.

The vehicle brake system 10 of the invention includes at least one supply container 12, which delivers brake fluid 16 to a master cylinder 14 and/or to at least one wheel brake, not shown here, of the vehicle brake system 10, and also includes a feed pump 28, communicating with the supply container 12 of the brake fluid 16 via a suction line 34 and the master cylinder 14. Moreover, a suction valve 30, which is preferably embodied as high-pressure capable, is disposed in the suction line 34. Moreover, the vehicle brake system 10 of the invention, for increasing the effective pressure in the supply container 12 of the brake fluid 16, has a precharging apparatus 18.

The components 12, 14, 18, 18.1, 18.2, 28, 30, 32, 34 of the vehicle brake system 10 are hydraulically interconnected in a manner known per se.

According to the invention, the precharging apparatus 18 includes a first precharging device 18.1, which generates the compressed air for increasing the pressure in the supply container 12 of the brake fluid 16 from exhaust gases of an exhaust system 22 of the vehicle, and/or a second precharging device 18.2, which generates the compressed air for increasing the pressure in the supply container 12 of the brake fluid 16 from the relative wind 24. In the exemplary embodiment shown of the vehicle brake system 10 of the invention, the effective pressure in the supply container 12 can be increased by means of the compressed air, advantageously by way of the actual air pressure in the surroundings 20 of the vehicle brake system 10.

This means that the precharging apparatus 18, or in other words the first precharging device 18.1 and/or the second precharging device 18.2 of the precharging apparatus 18, are arranged for increasing the pressure in the supply container 12 beyond the air pressure in the surroundings 20 of the vehicle brake system 10. For that purpose, the first precharging device 18.1 generates the compressed air for increasing the pressure from exhaust gases of the exhaust system 22, and the second precharging device 18.2 generates the compressed air for increasing the pressure from the relative wind 24. This means that by means of the compressed air generated by the vehicle exhaust system 22 and/or the compressed air generated by the relative wind 24 is fed into the supply container 12 of the brake fluid 16 and used for increasing the pressure in the supply container 12 of the brake fluid 16.

For utilizing the relative wind 24 for increasing the pressure in the supply container 12, the second precharging device 18.2 has at least one sealing element 26 for compressing the air of the relative wind 24. Preferably, the sealing element 26 is embodied essentially as a funnel element, which is preferably oriented in a primary travel direction of the vehicle. When the vehicle is in operation, the air from the relative wind 24 is compressed in the sealing element 26 and delivered to the supply container 12.

To save installation space, the funnel element 26 is advantageously disposed in the front region of the vehicle, preferably in the vicinity of a vehicle radiator, not shown here.

As mentioned, the precharging apparatus 18 is provided so that during operation of the vehicle brake system 10 it can intermittently generate an overpressure, that is, a pressure above the ambient air pressure, so that brake fluid 16 from the supply container 12, by overcoming flow resistances, can increasingly reach the feed pump 28. The master cylinder 14, the suction line 34, and the suction valve 30 act here as throttle baffles; that is, they each cause an unwanted pressure loss, which must be compensated for by the additional compressed air which is conducted into the supply container 12. The pressure loss is caused for instance by various bore diameters, deflections, and so forth in the involved components of the vehicle brake system 10.

Theoretically, a pressure of 0 bar prevails at the inlet to the feed pump 28. That is, a vacuum prevails. In the supply container 12, without the activated or effective precharging apparatus 18, the ambient air pressure of approximately 1000 mbar prevails; the maximum pressure difference between the supply container 12 and the inlet to the feed pump 28 is therefore equivalent to a value of 1000 mbar, which can be increased by the precharging apparatus 18.

In the vehicle brake system 10 of the invention, the first precharging device 18.1, via the relative wind generated by the motion of the vehicle, and/or the second precharging device 18.2, via the pressure in the vehicle exhaust system generated by the operation of the vehicle, automatically make sufficient compressed air available for raising the pressure in the supply container 12 of the brake fluid, so that an adequate flow of brake fluid from the supply container 12 into the master cylinder during vehicle operation is ensured, in the event that the vehicle brake system 10 requires an increased amount of brake fluid 16, for instance because of a vehicle dynamics control event. As a result of the described pressure increase in the supply container 12 beyond the ambient air pressure, a precharge is furnished for the feed pump 28, and this advantageously leads to a faster pressure buildup in the vehicle brake system 10 and thus to shorter control times for the desired vehicle dynamics control.

The foregoing relates to a preferred exemplary embodiment of the invention, it being understood that other variants and embodiments thereof are possible within the spirit and scope of the invention, the latter being defined by the appended claims.

1. A vehicle brake system, comprising:
at least one supply container for delivering brake fluid to a master cylinder and/or to at least one wheel brake of the vehicle brake system; and
a precharging apparatus for increasing an effective pressure in the supply container, in which the precharging apparatus generates compressed air for increasing the pressure, wherein
the precharging apparatus including a first precharging device, which generates the compressed air from exhaust gases of an exhaust system of the vehicle, and/or a second precharging device, which generates the compressed air from relative wind.

2. The vehicle brake system as defined by claim 1, wherein by means of the compressed air, the effective pressure in the supply container can be raised above an actual pressure surrounding the vehicle brake system.

3. The vehicle brake system as defined by claim 1, wherein the second precharging device has at least one sealing element for compressing air of the relative wind.

4. The vehicle brake system as defined by claim 2, wherein the second precharging device has at least one sealing element for compressing air of the relative wind.

5. The vehicle brake system as defined by claim 3, wherein the sealing element is embodied essentially as a funnel element.

6. The vehicle brake system as defined by claim 4, wherein the sealing element is embodied essentially as a funnel element.

7. The vehicle brake system as defined by claim 5, wherein the funnel element is disposed in a front region of the vehicle, preferably in a vicinity of a radiator of the vehicle.

8. The vehicle brake system as defined by claim 6, wherein the funnel element is disposed in a front region of the vehicle, preferably in a vicinity of a radiator of the vehicle.
